(19) United States
(12) Patent Application Publication
(10) Pub. No.: US 2017/0048293 A1
(43) Pub. Date: Feb. 16, 2017

(54) METHOD AND ELECTRONIC APPARATUS FOR IMPLEMENTING LIVE STREAMING OF MULTIMEDIA THROUGH EXTERNAL DEVICE

(71) Applicants: Le Holdings (Beijing) Co., Ltd., Beijing (CN); LE SHI INTERNET INFORMATION TECHNOLOGY CORP. BEIJING, Beijing (CN)

(72) Inventors: Shuo Huang, Beijing (CN); Jiancheng Huang, Beijing (CN); Ruike LI, Beijing (CN)

(21) Appl. No.: 15/246,751

(22) Filed: Aug. 25, 2016

Related U.S. Application Data
(63) Continuation of application No. PCT/CN2016/088510, filed on Jul. 5, 2015.

(30) Foreign Application Priority Data
Dec. 14, 2015 (CN) 201510925696.3

(51) Int. Cl. H04L 29/06; H04W 4/06; H04W 76/02

(52) U.S. Cl. CPC H04L 65/4076; H04W 76/025; H04L 65/60; H04L 65/80; H04W 4/06; H04W 84/12

(57) ABSTRACT

The present application provides a method and a mobile client for implementing live streaming of multimedia through an external device. The method includes: concurrently enabling a connection of a wireless local area network and a connection of a mobile network; connecting to the external device through the wireless local area network provided by the external device having a function of multimedia shooting; receiving a multimedia data stream sent by the external device through the wireless local area network, wherein, the multimedia data stream is obtained from a real-time shooting of the external device; sending the multimedia data stream to a server of multimedia live streaming through the mobile network. The present application solves the current problems of effects caused by a narrow scope of shooting and poor qualities of live streaming on users' experiences. The external device having a high professional function of video shooting can produce a high-quality multimedia data streaming so that the quality of the multimedia live streaming is increased to raise users' experiences.

### CROSS REFERENCE TO RELATED APPLICATIONS

This application is a continuation of International Application No. PCT/CN2016/088510PCT, filed on Jul. 5, 2016, which is based upon and claims priority to Chinese Patent Application No. 201510925696.3, titled as “METHOD AND MOBILE CLIENT FOR IMPLEMENTING LIVE STREAMING OF MULTIMEDIA THROUGH EXTERNAL DEVICE” and filed on Dec. 14, 2015, the entire contents of which are incorporated herein by reference.

### TECHNICAL FIELD

The invention relates to the filed of intelligent application, and more particularly to method and an electronic apparatus for implementing live streaming of multimedia through an external device.

### BACKGROUND

As a new way of internet sociality, the application of multimedia live streaming has become familiar to lots of people. The purpose of the application of multimedia live streaming is to provide convenient video sharing services to users anytime and anywhere.

The multimedia live streaming need to rely on devices having a function of video shooting, such as cell phones. The applications of the multimedia live streaming are installed in the cell phones and the video shootings are performed via cameras of the cell phones. Then the videos obtained by performing the video shootings are sent to audience via internet. However, the scopes of video shooting of cell phones are narrow and not able to reach wide scopes. Therefore, the qualities of the multimedia live streaming will be affected.

Based on this, some cameras having special shooting functions such as motion cameras, camera if unmanned aerial vehicles could be used. However, the applications of live streaming can not be installed in those devices. Those devices are capable of achieving the video shootings, but not capable of achieving multimedia live streaming. Even though those devices can overcome the problem of narrow scopes of shootings, those devices do not have the function of multimedia live streaming.

Therefore, the current applications of live streaming have problems of effects caused by a narrow scope of shooting and poor qualities of live streaming on users' experiences.

### SUMMARY

The embodiments of the present invention provide a method and an electronic apparatus for implementing live streaming of multimedia through an external device to solve problems of effects caused by a narrow scope of shooting and poor qualities of live streaming on users' experiences.

In a first aspect, the embodiment of the present invention provides a method for implementing live streaming of multimedia through an external device. The method includes:
Concurrently enabling a connection of a wireless local area network and a connection of a mobile network;
Connecting to the external device through the wireless local area network provided by the external device having a function of multimedia shooting;
Receiving a multimedia data stream sent by the external device through the wireless local area network, wherein, the multimedia data stream is obtained from a real-time shooting of the external device; and
Sending the multimedia data stream to a server of multimedia live streaming through the mobile network.

Alternatively, in the above method, the method of concurrently enabling a connection of a wireless local area network and a connection of a mobile network includes:
Turning on the mobile network;
Loading a drive of the wireless local area network;
Turning on the wireless local area network.

In the second aspect, the present disclosure further provides a non-volatile computer storage medium storing computer-executable instructions, the computer-executable instructions are configured to implement any of methods for implementing live streaming of multimedia through an external device in the present application.

In the third aspect, the present application further provides an electronic apparatus, includes:
at least one processor; and
a memory communicatively connected to the at least one processor; wherein,
   the memory stores instructions which could be processed by the at least one processor, the instructions are executed by the at least one processor so that the at least one processor is capable of implementing any of methods for implementing live streaming of multimedia through an external device in the present application.

In the method and mobile client for implementing live streaming of multimedia through an external device provided by the embodiments of the present disclosure, a multimedia data stream obtained by a real-time shooting of the external device is received via a wireless local are network and the received multimedia data stream is sent to a server of multimedia live streaming via a mobile network so that audiences watching the live streaming could download the multimedia data stream from the server. The receiving and the sending of the live multimedia data streaming are processed concurrently to solve the problems of effects caused by a narrow scope of shooting and poor qualities of live streaming on users' experiences. The external has a high professional function of video shooting for the multimedia data stream so that the image qualities of the live streaming is increased to raise users' experiences.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of method for implementing live streaming of multimedia through an external device in one embodiment of the present application;

FIG. 2 is a flow chart of method for implementing live streaming of multimedia through an external device in another embodiment of the present application;

FIG. 3 is a flow chart of method for implementing live streaming of multimedia through an external device in another embodiment of the present application;

FIG. 4 is a flow chart of method for implementing live streaming of multimedia through an external device in another embodiment of the present application;

FIG. 5 is a flow chart of method for implementing live streaming of multimedia through an external device in another embodiment of the present application;

FIG. 6 is a block diagram of mobile client for implementing live streaming of multimedia through an external device in one embodiment of the present application;

FIG. 7 is a block diagram of mobile client for implementing live streaming of multimedia through an external device in another embodiment of the present application;

FIG. 8 is a block diagram of mobile client for implementing live streaming of multimedia through an external device in another embodiment of the present application;

FIG. 9 is a block diagram of mobile client for implementing live streaming of multimedia through an external device in another embodiment of the present application; and

FIG. 10 is a block diagram of electronic apparatus in another embodiment of the present application.

### DETAILED DESCRIPTION

In order to clarify the purpose, technical solutions, and merits of the present application, the technical solutions in the embodiments of the present application are illustrated clearly and fully with figures of the embodiments of the present application. Obviously, the illustrated embodiments are not all embodiments but part of embodiments of the present application. Based on the embodiments of the present disclosure, other embodiments obtained by persons having ordinary skills in the art without creative efforts provided are within the scope of the present application.

### Embodiment 1

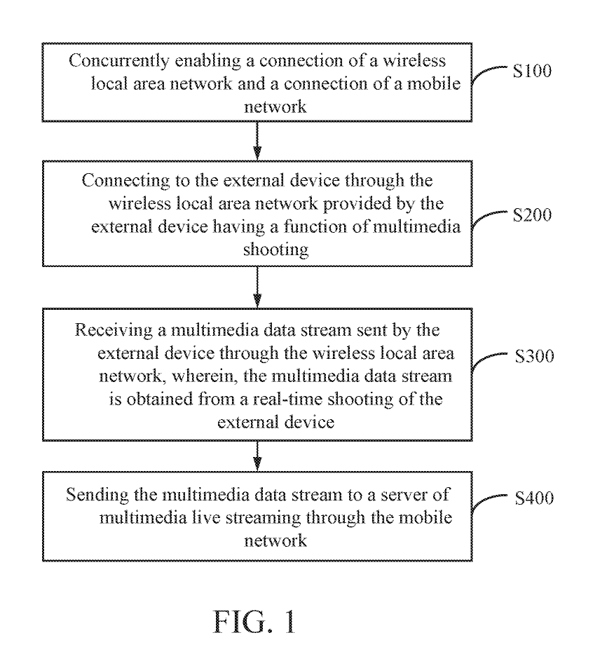

In order to solve the problems of effects of a narrow scope of shooting and poor qualities of live streaming on users' experiences, the embodiment 1 of the present application provides a method for implementing live streaming of multimedia through an external device. Wherein, the external device is an electronic apparatus having a function of video shooting for a multimedia data streaming. The electronic apparatus has the features of light volume, waterproofing, shock proofing, high endurance, large storage, etc. The typical apparatus includes GoPro Hero camera, a camera of an unmanned aircraft, etc. The electronic apparatuses listed above are just typical apparatuses of the technical field and the present disclosure is not limited to the electronic apparatuses; the applications of multimedia live streaming could be installed in intelligent terminals of smart cell phones, tablets having the applications of multimedia live streaming installed. A smart cell phone is taken as an example for describing in the embodiments of the present application. Please refer to FIG. 1. which is a flow chart of method for implementing live streaming of multimedia through an external device in the embodiment 1 of the present application, and the method includes:
Step S100, concurrently enabling a connection of a wireless local area network and a connection of a mobile network;
Step S200, connecting to the external device through the wireless local area network provided by the external device having a function of multimedia shooting;
Step S300, receiving a multimedia data stream sent by the external device through the wireless local area network, wherein, the multimedia data stream is obtained from a real-time shooting of the external device; and
Step S400, sending the multimedia data stream to a server of multimedia live streaming through the mobile network.

In the step S100, concurrently enabling a connection of a wireless local area network and a connection of a mobile network means turn-on of the mobile network connection and WIFI network connection. Herein, the achievements of present application are based on mobile terminals having the applications of multimedia live streaming installed, and a smart cell phone is taken as an example in the embodiment. The mobile terminal has to be able to support a mobile network module and a WLAN module so that the mobile terminal could connect to internet using a mobile network or WIFI. Wherein, the mobile network includes a 2G network, a 3G network and a 4G network. Herein, users could select the mobile network according to the multimedia live streaming and the area of live streaming. According to experiences of transmission in the field of communication, the transmission speed and the transmission quality of the 4G network are higher than the transmission speed and the transmission quality of the 3G network. The transmission speed and the transmission quality of the 3G network are higher than the transmission speed and the transmission quality of the 2G network. It is appropriate to use the 4G network to ensure the quality of the multimedia live streaming and the users' experiences.

Following the step S100, in the step S200, connect to the external device through the wireless local area network provided by the external device having a function of multimedia shooting. Specially, the external device is a device having a shooting function. Moreover, the external device needs to reflect a hot spot of the wireless local area network, which is a WIFI hotspot. The cell phone having the application of multimedia live streaming installed would connect to the WIFI hotspot. Thereby a connection of wireless local area network between the cell phone and external device is achieved. It is conceivable that it is necessary to connect the external device to a conversion device having a function of emitting a WIFI hotspot if the external device does not have the function of emitting a WIFI hotspot, so that the connection of wireless local area network between the cell phone and external device could be achieved through the conversion device. The examples listed above are several forms of achievements of the present disclosure. It is conceivable that other forms of achievements can be derived in the conception of the present application. However, the other forms of achievements should be considered to belong to the spirit of the present application and covered by the scope of the present application.

Following the step S200, in the step S300, receiving a multimedia data stream sent by the external device through the wireless local area network, wherein, the multimedia data stream is obtained from a real-time shooting of the external device. After a connection of wireless local area network between the cell phone and external device is achieved, the cell phone receives the multimedia data stream obtained by the shooting of the external device. Wherein, the multimedia data stream is obtained from a real-time shooting of the external device. The multimedia data stream includes an audio file and an image file. The audio file is a sound file to be live broadcasted and the image file is an image to be live broadcasted. The audio file and the image file correspond to each other in the timeline. Moreover, it should be noted that multimedia live streaming is implemented when the multimedia data stream includes both the audio file and the image file. Audio live streaming is implemented when the audio file is independently received. The image file can be independently received. For example, photo slides show is played if the external device shoots a photo. Herein, the users are allowed to freely select any way of live streaming according to demands and conditions of internet transmission.

Following the step S300, in the step S400, sending the multimedia data stream to a server of multimedia live streaming through the mobile network. Specifically, the cell phone concurrently sends the multimedia data stream to a server terminal having video live streaming appliance via the mobile network of the cell phone after receiving the multimedia data stream sent from the external device. Further the user watching the multimedia live streaming would download the multimedia data stream from the server terminal via the video live streaming appliances of their terminals. Wherein, the cell phone sends the multimedia data stream via the mobile network. The cell phone receives the multimedia data streaming via the WIFI network emitted by the external device. The sending and the receiving are processed concurrently and would not affect each other and the effects are the same as the effects that the multimedia live streaming through the cell phone camera achieves.

It is noted that the cell phone could run other programs when processing the receiving and the sending of the multimedia data stream. That is, the event of multimedia live streaming only occupies part of the process of the cell phone, and will not affect other function of the cell phone. For example, the cell phone could turn on its camera to shoot videos or shoot photos, etc, and record the process of live streaming of the external device, which can be shared to social friends.

Receive a multimedia data stream sent by the external device through the wireless local area network, and send the received multimedia data stream to a server of multimedia live streaming through the mobile network so that audiences watching the multimedia live streaming could download the multimedia data stream for watching. The sending and the receiving of the live multimedia data stream are processed concurrently to solve the problems of effects of a narrow scope of shooting and poor qualities of live streaming on users' experiences. Moreover, the external has a high professional function of shooting for the multimedia data stream so that the image quality of the live streaming is increased to raise users' experiences.

### Embodiment 2

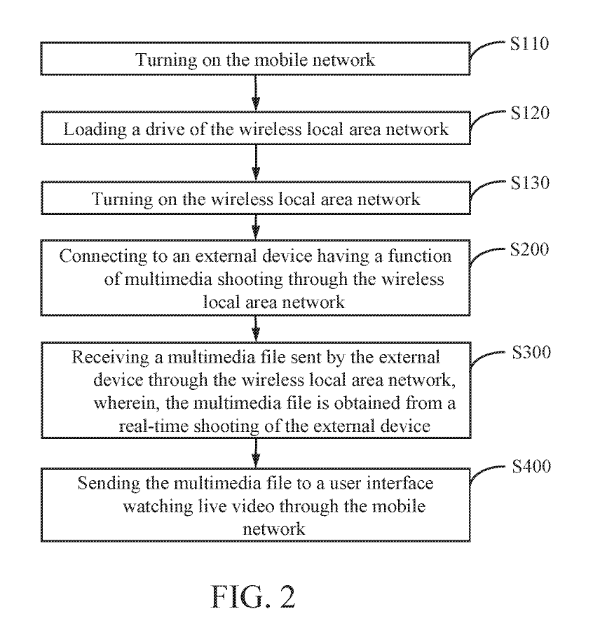

Please refer to FIG. 2, which is a flow chart of a method for implementing live streaming of multimedia through an external device in the embodiment 2 of the present application. The embodiment is based upon the embodiment 1, and the concurrently enabling the connection of the wireless local area network and the connection of the mobile network further includes:
Step 110, turning on the mobile network;
Step 120, loading a drive of the wireless local area network; and
Step 130, turning on the wireless local area network.

In the step S110, a user turns on the mobile network of the cell phone in the network setup options of the cell phone. At this time, it has to be ensured that the wireless local area network is in off-state.

Following the step S110, in the step S120, first of all, determine whether a driver of the wireless local area network is loaded into the cell phone, wherein, the wireless local area network is a WIFI network reflected by the external device.

If the driver of the wireless local area network is loaded into the cell phone, it means that the cell phone has the condition for connecting to the WIFI network reflected by the external device. Turning on the wireless local area network (step S130) will concurrently enabling a connection of a wireless local area network and a connection of a mobile network. That is, if the driver of the wireless local area network is loaded into the cell phone, directly implement the step S130.

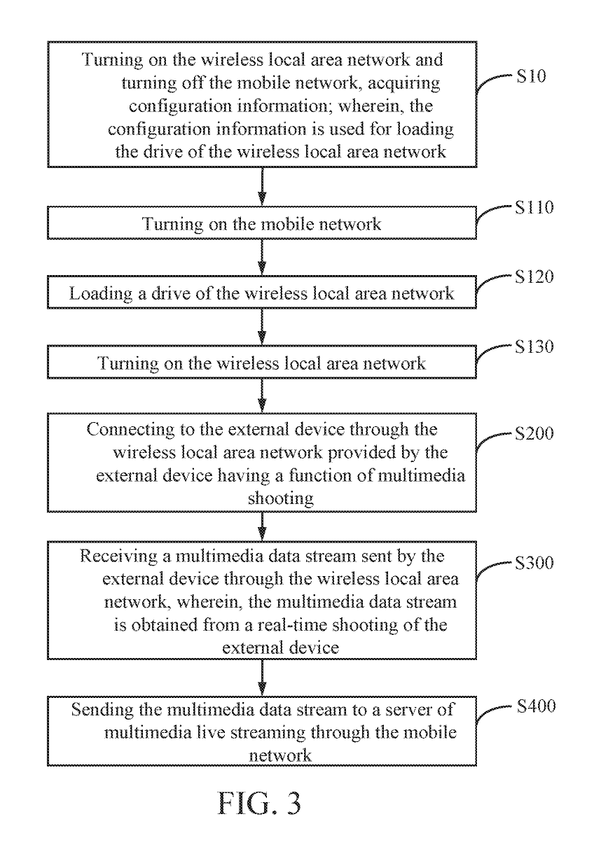

However, in most situations, a driver of the wireless local area network is not loaded into the cell phone. At this time, a driver of the wireless local area network needs to be loaded into the cell phone so that the cell phone has the condition for connecting to the WIFI network reflected by the external device. Please refer to FIG. 3, before concurrently enabling the connection of the wireless local area network and the connection of the mobile network further includes:
Step S10, turning on the wireless local area network and turning off the mobile network, acquiring configuration information; wherein, the configuration information is used for loading the drive of the wireless local area network.

Specifically, before concurrently enabling the connection of the wireless local area network and the connection of the mobile network, first of all, turn on the wireless local area network and ensure that the mobile network is off. Secondly, search the WIFI network emitted by the external device and process the connection of the wireless local area network. Finally, acquire the configuration information of the WIFI network emitted by the external device after successfully connecting to the WIFI network emitted by the external device. Herein, the configuration information can include information such as the type of the network interface card, IP address and network transmission parameters, etc. The configuration information is used for loading the drive of the wireless local area network. It is conceivable that a configuration file of the WIFI network emitted by the external device can be temporarily generated I the cell phone after the configuration information is acquired.

After the cell phone acquires the configuration information (the configuration file), the drive of the wireless local area network is loaded into the cell phone as the mobile network is in on-state. That is, the drive of the WIFI network emitted by the external device is loaded into the cell phone. That is because the mobile network of the cell phone and the wireless local area network can not be turned on concurrently unless the wireless local area network having the configuration information (the configuration file) is manually loaded as the mobile network of the cell phone is in on-state. Herein, the drive of the WIFI network emitted by the external device could be manually loaded by reading the configuration information, or the drive of the WIFI network emitted by the external device could be loaded through automatically running the configuration file. The present application is not limited to it. After the drive of the WIFI network emitted by the external device has loaded, the network interface card of the cell phone would obtain an IP address of the WIFI network emitted by the external device. The mobile network of the cell phone keeps being in the connected state in the process. That is, the cell phone could also obtain an IP address of the mobile network. In other words, the cell phone has had the condition of concurrently turning on the two networks.

Following the step S120, in the step 130, after the cell phone has the condition of concurrently turning on the two networks, enable the connection of the wireless local area network in the network setup options of the cell phone so that the cell phone connects to the WIFI network emitted by the external device. At this time, the mobile network of the cell phone is also in connected state so that the connection of the wireless local area network and the connection of the mobile network can be enabled concurrently.

Record the configuration information of the wireless local area network through connecting to the wireless local area network once. Then the connection of the wireless local area network and the connection of the mobile network can be enabled concurrently by turning on the wireless local area network through the configuration information when the mobile network is in on-state. During the process of live broadcasting multimedia files, the multimedia data stream can be concurrently received and sent to ensure the possibility of implementing the multimedia live streaming through the external device.

The examples listed above are several forms of achievements of the present application. It is conceivable that other forms of achievements can be derived in the conception of the present application. However, the other forms of achievements should be considered to belong to the spirit of the present application and covered by the scope of the present application.

### Embodiment 3

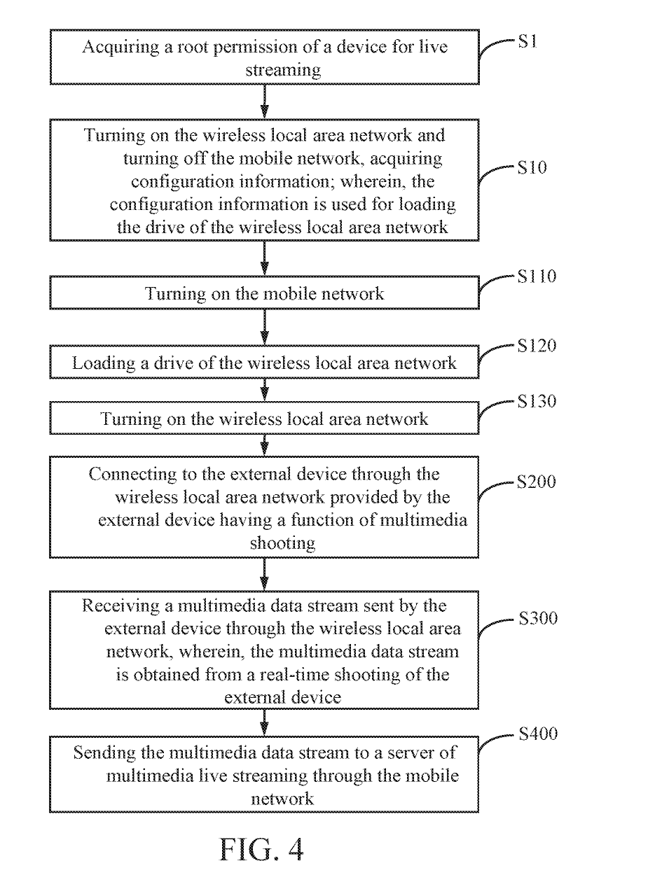

Please refer to FIG. 4, which is a flow chart of method for implementing live streaming of multimedia through an external device in the embodiment 3 of the present application. The embodiment is based upon the embodiment 2. In the step S10, before turning on the wireless local area network and turning off the mobile network, acquiring configuration information, the method further includes:
In step S1, acquiring a root permission of a device for live streaming.

In the step S1, acquiring a root permission of a device for live streaming. Specifically, before implementing multimedia live streaming through the external device, rooting the cell phone to acquire the ROOT permission of the cell phone. The ROOT permission is one kind of root permissions of a cell phone system. The ROOT permission can be considered to be as same as system permission, but higher than administration permission. Root is the super administrator user account in the Linux and unix system. The user account has most powerful right in the whole system and can control all objectives. Therefore, lots of hackers would like to raise the permission to the root permission when hacking into systems. From the point of view of windows, hackers add their own illegal accounts into user groups of administrators.

After acquiring root permission, it means that the highest permission of the system is acquired. At this time, you are allowed to implement all operations including adding, deleting, changing, checking to any files including system files. Then the drive of the wireless local area network can be load into the cell phone by acquiring the configuration information of the wireless local area network in the condition that the mobile network is in on-state. Thereby the connection of the mobile network and the connection of the wireless local area network can be in progress concurrently.

### Embodiment 4

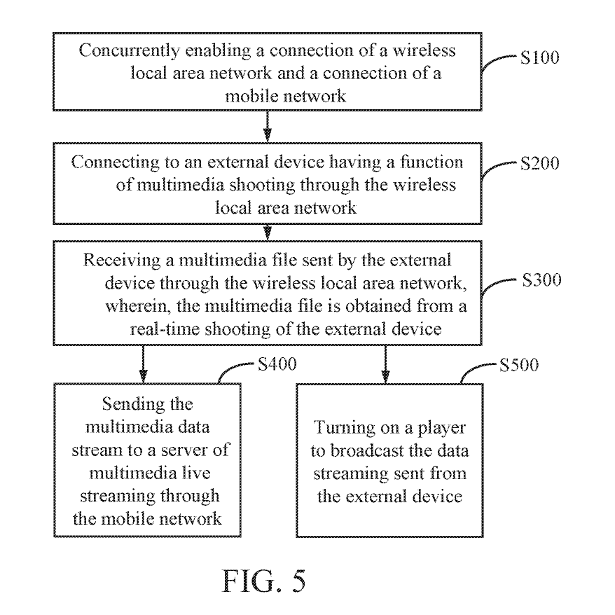

Please refer to FIG. 5, which is a flow chart of method for implementing live streaming of multimedia through an external device in the embodiment 4 of the present application. The embodiment is based upon the embodiment 1. In the step S300, after receiving a multimedia data stream sent by the external device through the wireless local area network, the method further includes:
Step S500, turning on a player to broadcast the multimedia data streaming sent from the external device.

In the step S500, after the cell phone receives the multimedia data stream sent from the external device, the application of the multimedia live streaming in the cell phone automatically turns on a player in a page of the multimedia live streaming. The player is configured to broadcast the multimedia data streaming sent from the external device. Herein, the operation of receiving the multimedia data streaming through the cell phone and the operation of broadcasting the multimedia data streaming through the player could be implemented concurrently. Because of internet transmission, a certain cache can be set so that the player is turned on to broadcast as a caching value is reached. Moreover, in order to ensure the quality of the multimedia live streaming, the video files sent from the cell phone to the user interface could have latency through a setting so that the live broadcasting of the player can be in progress after the broadcaster finishes a preview audit. When the broadcaster finds that the multimedia data streaming obtained by the shooting of the external device is not ideal, the sending process to the external device of the audiences watching multimedia live streaming would be terminated. The quality of the multimedia live streaming can be ensured and the experiences of users are raised.

### Embodiment 5

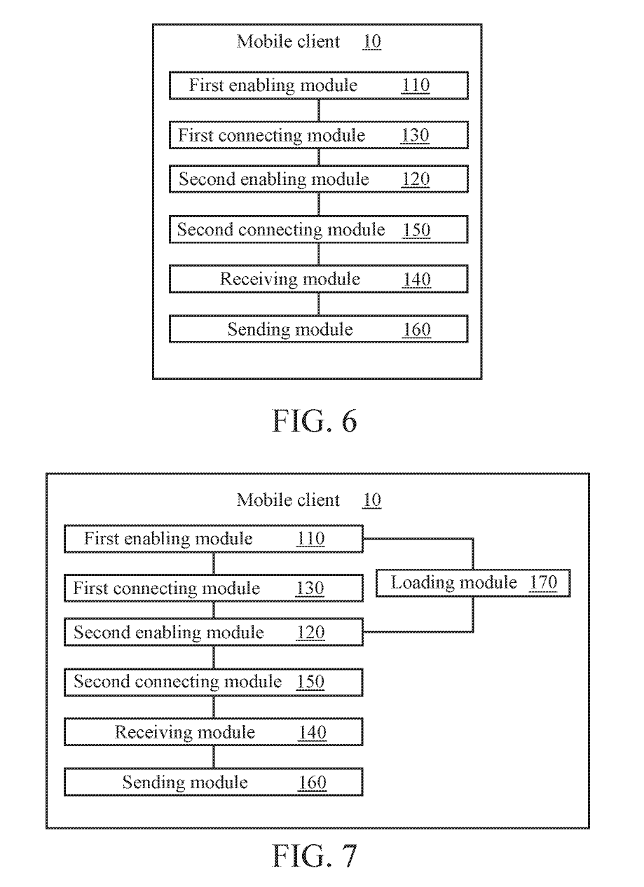

In order to solve problems of effects caused by a narrow scope of shooting and poor qualities of live streaming on users' experiences, the embodiment 5 of the present application provides a mobile client for implementing live streaming of multimedia through an external device. Wherein, the external device is an electronic apparatus having a function of video shooting for a multimedia data streaming. The electronic apparatus has the features of light volume, waterproofing, shock proofing, high endurance, large storage, etc. The typical apparatus includes GoPro Hero camera, a camera of an unmanned aircraft, etc. The electronic apparatuses listed above are just typical apparatuses of the technical field and the present application is not limited to the electronic apparatuses; the applications of multimedia live streaming could be installed in intelligent terminals of smart cell phones, tablets having the applications of multimedia live streaming installed. A smart cell phone is taken as an example for describing in the embodiments of the present application. Please refer to FIG. 6, which is a block diagram of mobile client for implementing live streaming of multimedia through an external device in the embodiment 5 of the present application. The mobile client 10 includes a first enabling module 110, a second enabling module 120, a first connecting module 130, a receiving module 140, a second connecting module 150 and a sending module 160.

A first enabling module 110 is configured to enable a connection of a wireless local area network.

A second enabling module 120 is configured to enable a connection of a mobile network.

A first connecting module 130 is configured to connect to the external device having a function of multimedia shooting through the wireless local area network.

A receiving module 140 is configured to receive a multimedia data stream sent by the external device through the wireless local area network, wherein, the multimedia data stream is obtained from a real-time shooting of the external device.

A second connecting 150 module is configured to connect to a server of multimedia live streaming through the mobile network.

A sending module 160 is configured to send the multimedia data stream to the server of multimedia live streaming through the mobile network.

Moreover, the multimedia data stream includes an audio file and an image file. The audio file is a sound file to be live broadcasted and the image file is an image to be live broadcasted. The audio file and the image file correspond to each other in the timeline. Moreover, it should be noted that multimedia live streaming is implemented when the multimedia data streaming includes both the audio file and the image file. Audio live streaming is implemented when the audio file is independently received. The image file can be independently received. For example, photo slides show is played if the external device shoots a photo. Herein, the users are allowed to freely select any way of live streaming according to demands and conditions of internet transmission.

The mobile network includes a 2G network, a 3G network and a 4G network. Herein, users could select the mobile network according to the multimedia live streaming and the area of live streaming. According to experiences of transmission in the field of communication, the transmission speed and the transmission quality of the 4G network are higher than the transmission speed and the transmission quality of the 3G network. The transmission speed and the transmission quality of the 3G network are higher than the transmission speed and the transmission quality of the 2G network. It is appropriate to use the 4G network to ensure the quality of the multimedia live streaming and the users' experiences.

The receiving module receives the multimedia data streaming obtained from the real-time shooting of the external device through the wireless local area network. The sending module sends the received multimedia data streaming to the server of multimedia live streaming so that the audiences watching multimedia live streaming can download the multimedia data streaming form the server for watching. The receiving and the sending of the live multimedia data streaming are processed concurrently to solve the problems of effects caused by a narrow scope of shooting and poor qualities of live streaming on users' experiences. The external has a high professional function of video shooting for the multimedia data stream so that the image qualities of the live streaming is increased to raise users' experiences.

### Embodiment 6

Please refer to FIG. 7, which is a block diagram of mobile client for implementing live streaming of multimedia through an external device in the embodiment 7 of the present application. The embodiment is based upon the embodiment 5. The mobile client 10 further includes a loading module 170.

The loading module 170 is configured to load a drive of the wireless local area network after the second enabling module 120 enables the connection of the mobile network and before the first enabling module 110 enables the connection of the wireless local area network.

### Embodiment 7

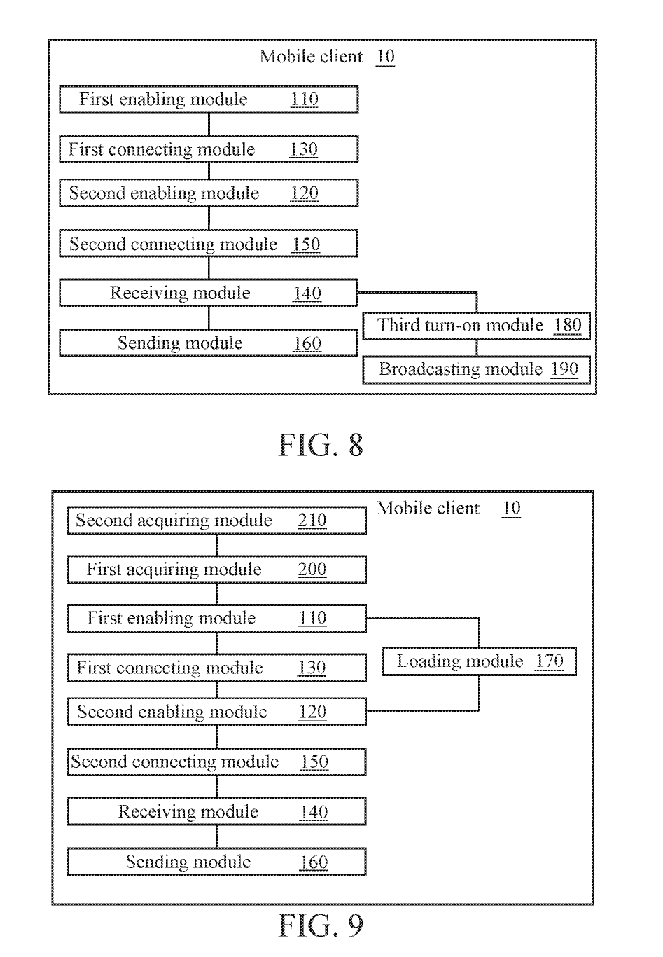

Please refer to FIG. 8, which is a block diagram of mobile client for implementing live streaming of multimedia through an external device in the embodiment 7 of the present application. The embodiment is based upon the embodiment 5. The mobile client 10 further includes a third turn-on module 180 and a broadcasting module 190.

The third turn-on module 180 is configured to turn on a player after the receiving module receive the multimedia data stream sent by the external device through the wireless local area network;

The broadcasting module 190 is configured to broadcast the multimedia data stream after the third turn-on module turns on the player.

### Embodiment 8

Please refer to FIG. 9, which is a block diagram of mobile client for implementing live streaming of multimedia through an external device in the embodiment 8 of the present application. The embodiment is based upon the embodiment 6. The mobile client 10 further includes a first acquiring module 200 and a second acquiring module 210.

A first acquiring module 200 is configured to acquire a configuration information of the wireless local area network when the first enabling module 110 enables the connection of the wireless local area network and the second enabling module 120 does not enable the connection of the mobile network, wherein, the configuration information is used for loading the drive of the wireless local area network.

A second acquiring module 210 is configured to acquire a root permission of a device for live streaming before the first acquiring module 200 acquires the configuration information of the wireless local area network.

Please refer to the aforementioned the embodiments of the method for implementing live streaming of multimedia through an external device if there is any inadequacy in the embodiments of mobile client for implementing live streaming of multimedia through an external device.

The embodiment 9 of the present application provides a non-volatile computer storage medium storing computer-executable instructions, the computer-executable instructions are capable of implementing a method for implementing live streaming of multimedia through an external device in any of above method embodiments.

### Embodiment 10

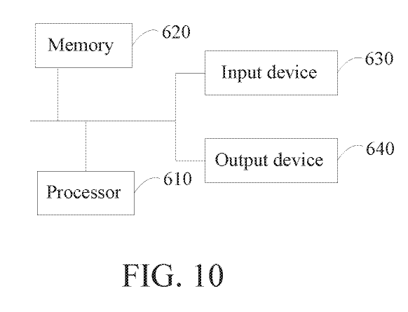

FIG. 10 is a block diagram of electronic apparatus for implementing live streaming of multimedia through an external device in the embodiment 10 of the present application. As shown in FIG. 10, the apparatus includes:
One or more processors 610 and a memory 620, and a processor 610 is an example in FIG. 10.

The apparatus for implementing the processing method of operation list items further includes: input device 630 and output device 640.

The processor 610, the memory 620, input device 630 and output device 640 can be connected to each other via a bus or other members for connection. In FIG. 10, they are connected to each other via the bus in this embodiment.

The memory 620 is one kind of non-volatile computer-readable storage mediums applicable to store non-volatile software programs, non-volatile computer-executable programs and modules; for example, the program instructions and the function modules corresponding to the method for implementing live streaming of multimedia through an external device (the first enabling module 110, the second enabling module 120, a first connecting module 130, a receiving module 140, a second connecting module and a sending module 160 in FIG. 6) in the embodiments are respectively a computer-executable program and a computer-executable module. The processor 610 executes function applications and data processing of the server by running the non-volatile software programs, non-volatile computer-executable programs and modules stored in the memory 620, and thereby the methods for implementing live streaming of multimedia through an external device in the aforementioned embodiments are achievable.

The memory 620 can include a program storage area and a data storage area, wherein the program storage area can store an operating system and at least one application program required for a function; the data storage area can store the data created according to the usage of the device for implementing live streaming of multimedia through an external device. Furthermore, the memory 620 can include a high speed random-access memory, and further include a non-volatile memory such as at least one disk storage member, at least one flash memory member and other non-volatile solid state storage member. In some embodiments, the memory 620 can have a remote connection with the processor 610, and such memory can be connected to the device for implementing live streaming of multimedia through an external device by a network. The aforementioned network includes, but not limited to, internet, intranet, local area network, mobile communication network and combination thereof

The input device 630 can receive digital or character information, and generate a key signal input regarding a user setup of the device for implementing live streaming of multimedia through an external device and a function control. The output device 640 can include a displaying unit such as screen.

The one or more modules are stored in the memory 620. When the one or more modules are executed by one or more processor 620, the method for implementing live streaming of multimedia through an external device disclosed in any one of the embodiments is performed.

The aforementioned product can execute the method provided by the embodiments of the present application and have a block module and benefits corresponding to the executing method. Technical details not described clearly in the embodiment can be found in the method for implementing live streaming of multimedia through an external device provided by the embodiments of the present application.

The electronic apparatus in the embodiments of the present application may be presence in many forms including, but not limited to:
(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.
(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.
(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.
(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.
(5) Other electronic apparatus having a data exchange function.

The embodiments of device described above are exemplary, wherein the units described as separate components could be or could not be physically separated. The components used for unit display could be or could not be physical units. The components could be located in one place or could be spread over multiple network elements. According to the actual demand, part of modules or all modules can be selected to achieve the purpose of the embodiments of the present disclosure. Persons having ordinary skills in the art could realize and implement the embodiments of the present disclosure without providing creative efforts.

Through the above descriptions of embodiments, those skilled in the art can clearly realize each embodiment can be implemented using software plus essential common hardware platforms. Certainly each embodiment can be implemented using hardware. Based on the understanding, the above technical solutions or part of the technical solutions contributing to the prior art could be embodied in form of software products. The computing software products can be stored in a computer-readable storage medium such as ROM/RAM, disk, compact disc, etc.

The computing software products include several instructions configured to make a computing device (a personal computer, a server, or internet device, etc) carry out the methods in each embodiments or part of methods in the embodiments.

Finally, it should be noted that: the above embodiments are just used for illustrating the technical solutions of the present disclosure and not for limiting the present application. Even though the present application is illustrated clearly referring to the previous embodiments, persons having ordinary skills in the art should realize the technical solutions described in the aforementioned embodiments can be modified or part of technical features can be displaced equivalently. The modification or the displacement would not make corresponding essentials of the technical solutions out of spirit and scope of the technical solution of each embodiment of 1 0 the present application.

What is claimed is:

1. A method for implementing live streaming of multimedia through an external device applied to a terminal, comprising:
concurrently enabling a connection of a wireless local area network and a connection of a mobile network;
connecting to the external device through the wireless local area network provided by the external device having a function of multimedia shooting;
receiving a multimedia data stream sent by the external device through the wireless local area network, wherein, the multimedia data stream is obtained from a real-time shooting of the external device; and
sending the multimedia data stream to a server of multimedia live streaming through the mobile network.

2. The method for implementing live streaming of multimedia through the external device according to claim 1, the method of concurrently enabling the connection of the wireless local area network and the connection of the mobile network further comprising:
turning on the mobile network;
loading a drive of the wireless local area network; and
turning on the wireless local area network.

3. The method for implementing live streaming of multimedia through the external device according to claim 2, before concurrently enabling the connection of the wireless local area network and the connection of the mobile network further comprising:
turning on the wireless local area network and turning off the mobile network, acquiring configuration information; wherein, the configuration information is used for loading the drive of the wireless local area network.

4. The method for implementing live streaming of multimedia through the external device according to claim 3, before turning on the wireless local area network and turning off the mobile network, acquiring configuration information further comprising:
acquiring a root permission of a device for live streaming.

5. The method for implementing live streaming of multimedia through the external device according to claim 1, further comprising:
turning on a player to broadcast the data streaming sent from the external device.

6. A non-volatile computer storage medium storing computer-executable instructions, the computer-executable instructions set as:
concurrently enabling a connection of a wireless local area network and a connection of a mobile network;
connecting to the external device through the wireless local area network provided by the external device having a function of multimedia shooting;
receiving a multimedia data stream sent by the external device through the wireless local area network, wherein, the multimedia data stream is obtained from a real-time shooting of the external device; and
sending the multimedia data stream to a server of multimedia live streaming through the mobile network.

7. A electronic apparatus, comprising:
at least one processor; and
a memory communicatively connected to the at least one processor; wherein,
the memory stores instructions which could be processed by the at least one processor, the instructions are executed by the at least one processor so that the at least one processor is capable of:
concurrently enabling a connection of a wireless local area network and a connection of a mobile network;
connecting to the external device through the wireless local area network provided by the external device having a function of multimedia shooting;
receiving a multimedia data stream sent by the external device through the wireless local area network, wherein, the multimedia data stream is obtained from a real-time shooting of the external device; and
sending the multimedia data stream to a server of multimedia live streaming through the mobile network.

8. The non-volatile computer storage medium according to claim 6, the method for concurrently enabling the connection of the wireless local area network and the connection of the mobile network, further comprising:
turning on the mobile network;
loading a drive of the wireless local area network; and
turning on the wireless local area network.

9. The non-volatile computer storage medium according to claim 8, wherein, before concurrently enabling the connection of the wireless local area network and the connection of the mobile network, the computer-executable instructions is further set as:
turning on the wireless local area network and turning off the mobile network, acquiring configuration information; wherein, the configuration information is used for loading the drive of the wireless local area network.

10. The non-volatile computer storage medium according to claim 9, wherein, before turning on the wireless local area network and turning off the mobile network, acquiring configuration information, the computer-executable instructions is further set as:
acquiring a root permission of a device for live streaming.

11. The non-volatile computer storage medium according to claim 6, wherein, the computer-executable instructions is further set as:
turning on a player to broadcast the data streaming sent from the external device.

12. The electronic apparatus according to claim 7, the method for concurrently enabling the connection of the wireless local area network and the connection of the mobile network further comprising:
turning on the mobile network;
loading a drive of the wireless local area network; and
turning on the wireless local area network.

13. The electronic apparatus according to claim 12, wherein, before concurrently enabling the connection of the wireless local area network and the connection of the mobile network, the processor is further capable of:
turning on the wireless local area network and turning off the mobile network, acquiring configuration information; wherein, the configuration information is used for loading the drive of the wireless local area network.

14. The electronic apparatus according to claim 13, wherein, before turning on the wireless local area network and turning off the mobile network, acquiring configuration information the processor is further capable of:
acquiring a root permission of a device for live streaming.

15. The electronic apparatus according to claim 7, wherein, the processor is further capable of:
turning on a player to broadcast the data streaming sent from the external device.
